(19) United States
(12) Patent Application Publication
(10) Pub. No.: US 2019/0244030 A1
(43) Pub. Date: Aug. 8, 2019

(54) OBJECT TRACKING IN VIDEO USING BETTER OBJECT AREA

(71) Applicant: HITACHI, LTD., Tokyo (JP)

(72) Inventor: Tomoaki YOSHINAGA, Cupertino, CA (US)

(73) Assignee: HITACHI, LTD.

(21) Appl. No.: 15/891,225

(22) Filed: Feb. 7, 2018

(51) Int. Cl. G06K 9/00; G06F 17/30; G06T 7/20

(52) U.S. Cl. CPC G06K 9/00744; G06T 7/20; G06F 17/3079; G06K 9/00201

(57) ABSTRACT

Example implementations described herein are directed to systems and methods to improve the accuracy of tracking an object through multiple frames in a video. Example implementations involve obtaining an area to be used to tracking separate from the area indicated as the object. In example implementations, the tracking area for an object is generated, whereupon the object can be tracked on a live or archived video feed.

### BACKGROUND

### Field

The present disclosure is generally directed to object tracking, and more specifically, to systems and methods for object tracking in video.

### Related Art

Object tracking technology automatically follows the position of a given object on a plurality of frames in a video. More precisely, given an area in a frame (i.e. the “object area”), object tracking estimates where this area is located in subsequent frames. There are no restrictions on what the object might be, but usual examples can include a face, a person, a vehicle, or other objects according to the desired implementation.

The tracking process starts by selecting an object area on an initial video frame. This object area is selected automatically by a routine to detect the target object, or manually. Then object tracking estimates the same object area on the next frame by comparing image features extracted from the initial frame and the next frame. By repeating this process, the object can be tracked for a plurality of frames.

There are several related art algorithms for object tracking. In an example related art implementation directed to a high speed and accurate tracking method, there are two sequential matching methods to find the area. At first, the position and size matching can find the desired area quickly, and if the first matching method fails, the second matching method can find object exiting at a distance from the previous frame by using feature matching. The method can track objects located at a far area with low cost.

### SUMMARY

There are two main applications of tracking. The first is to link objects in a plurality of frames. For instance, by tracking a person through multiple frames we can determine that it is the same person. Also, automatic detection might be computationally expensive, so instead of detecting the object on every frame one can detect the object every n frames and use tracking in between. This will reduce computation time if tracking is less computationally expensive than detection.

Object tracking may be used for multiple areas. On industrial applications, it can be used to track workers or vehicles in a factory floor, or track parts going through an assembly line. This may be used as input to different applications, e.g. to find problems in an assembly line by detecting employees in unexpected places.

A tracking application example that involves manually specifying the object area is video redaction. It is used to conceal privacy-related information such as faces or license plates on a video prior to public disclosure. Instead of specifying the objects to redact on every frame, the object area to redact can be indicated on a frame and then this object area can be tracked in subsequent frames, reducing the manual work.

Sometimes object tracking fails to correctly track an object area, and one possible cause is that the object area is not suited for the tracking algorithm. The accuracy of the tracking process is affected by the object area, and e.g. selecting a wider or narrower object area around the object may change the accuracy. However, users have no idea how an application tracks objects so they select an area on the frame which they think corresponds to the object, not the area that is the best one for tracking. For example, when users want to track a human face on a video, it is unknown for them whether the best area to track is whole head, a wider area including little background, or just the area including the eyes, nose and mouth. The choice of area varies depending on the user, so the tracking accuracy will be inconsistent for different users. The same problem exists when object areas are selected by object detection, because detection and tracking algorithms are totally different in general, so the area given by the object detector might not be the best for tracking.

In related art tracking implementations, there are no particular implementations for the selection of the area used for tracking. If a bad area is selected, the related art implementations may not work effectively, as the area selected affects the ability for related art implementations to track objects.

Example implementations as described herein solve the problem of realizing accurate and robust object tracking which is less affected by manual object selection and by the algorithm of object detection.

Example implementations as described herein utilize a “tracking area” for tracking that is separate from the “object area”, and can track the object with higher accuracy than using the “object area”. A tracking area estimation process calculates a better area for tracking (the tracking area) using as one of the inputs the position of the object area. Then, the results of tracking on the tracking area are reflected back to the object area, generating tracking for the object area.

The tracking area estimation process is generally required only at the initial stage of tracking. The additional processing cost is low, and it improves the tracking results for many subsequent frames. It is very effective especially when the correct object area is unclear.

Example implementations as described herein may involve a method that involves, for a video feed with a provided object area of an object to be tracked, estimating a tracking area directed to the object to be tracked based on the provided object area and a scoring function, and utilizing the tracking area to track the object in the video feed.

Example implementations as described herein may involve a non-transitory computer readable medium storing instructions that involves, for a video feed with a provided object area of an object to be tracked, estimating a tracking area directed to the object to be tracked based on the provided object area and a scoring function, and utilizing the tracking area to track the object in the video feed.

Example implementations as described herein may involve a system that involves, for a video feed with a provided object area of an object to be tracked, means for estimating a tracking area directed to the object to be tracked based on the provided object area and a scoring function, and means for utilizing the tracking area to track the object in the video feed.

### BRIEF DESCRIPTION OF DRAWINGS

FIG. 1 illustrates an example flow for robust object tracking, in accordance with an example implementation.

FIG. 2 illustrates an object tracking unit and some units included in the unit, in accordance with an example implementation.

FIG. 3 illustrates an example object tracking system on which the tracking unit works, in accordance with an example implementation.

FIG. 4 illustrates an example processing flow of the first example implementation.

FIG. 5 illustrates examples of image augmentation techniques, in accordance with an example implementation.

FIG. 6 illustrates a processing flow of method to estimate object tracking area, in a second example implementation.

FIG. 7 illustrates an image representing the third example implementation for the tracking area estimation, hereinafter referred to as cell area based estimation.

FIG. 8 is a sample of a Graphical User Interface (GUI) tool for object area selection, in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

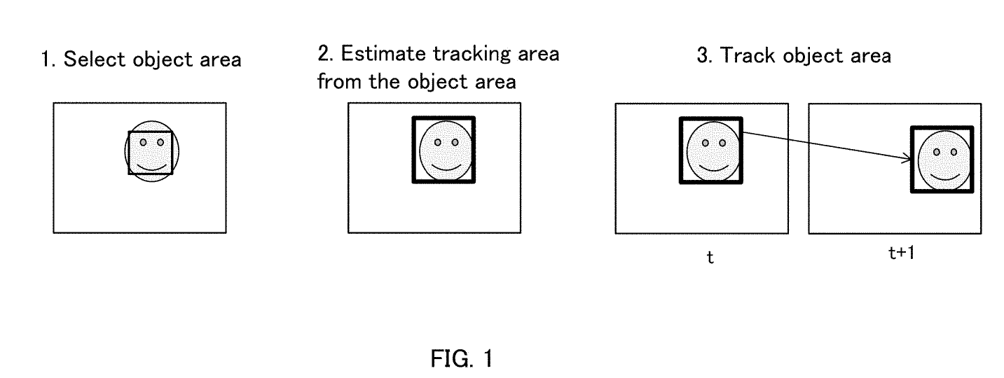

FIG. 1 illustrates an example for robust object tracking in accordance with an example implementation. When the object area is detected automatically or selected manually, the application estimates a better tracking area from the object area. Then, the tracking area is used for tracking. This estimation process is done at just the first frame of the tracking. As described herein, example implementations involve, for a video feed with a provided object area of an object to be tracked, the estimating of a tracking area for the object to be tracked based on the provided object area and a scoring function; and utilizing the candidate tracking area to track the object in the video feed.

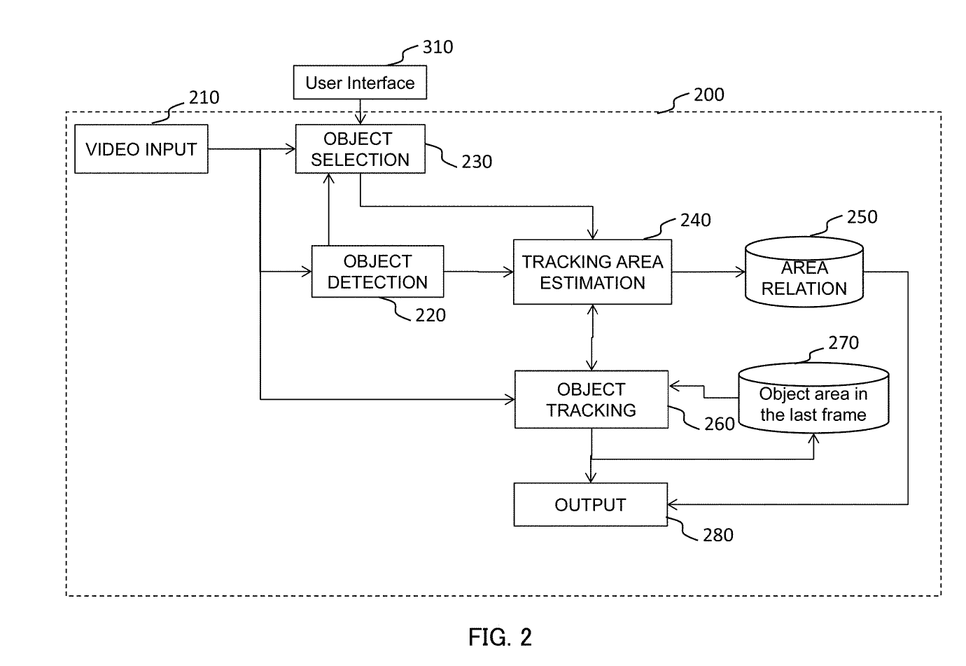

FIG. 2 illustrates an object tracking unit 200 and some units included in the unit 200, in accordance with an example implementation. In the example of FIG. 2, Video input unit 210 can get video data from outside and output sequential image frames of the video to the object detection unit 220 and the object selection unit 230.

Object Detection unit 220 conducts image recognition to detect specific objects. For example, faster-R Convoluted Neural Networks (CNNs) can output multiple object areas. Object selection unit 230 can get metadata from a user interface. This metadata contains object area location and size on the current frame. This unit gets such type of data when the object area is manually added, or the object is obtained from the object detection unit 220 and manually modified. Tracking area estimation unit 240 gets metadata of object area in the current frame from the object detection unit 220 and the object selection unit 230. For objects in which the tracking is being corrected in the user interface 310, the metadata is sent directly to object tracking unit 260. The relation between the object area and the tracking area is stored into an area relation unit 250.

Object tracking unit 260 performs object tracking by using the tracking area information of the previous frame. Object Unit 260 can get other metadata in current frame from the estimation unit 240, and decides the current tracking area location and size. The results are stored into the unit 270.

Output unit 280 obtains the results of the object tracking and the relationship between the object area and the tracking area. For instance, the object area is moved and scaled in a similar way to the tracking area, thus reflecting the tracking done through the tracking area back to the object area. The output unit 280 output metadata of the object area.

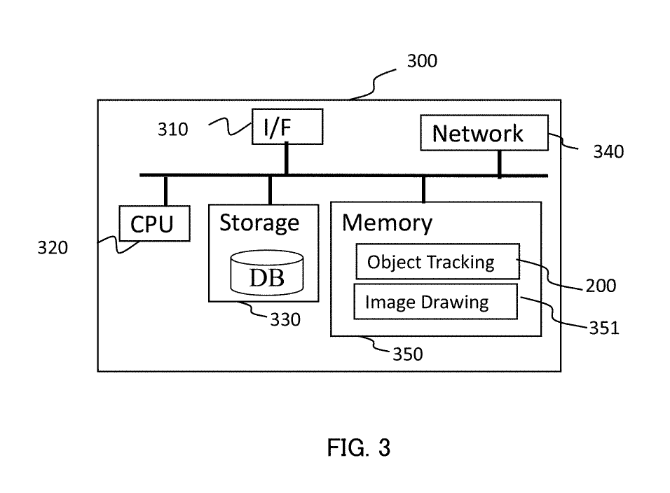

FIG. 3 illustrates an example object tracking system on which the tracking unit works, in accordance with an example implementation. The system 300 can involve a user and/or a network interface 310, a central processing unit (CPU) 320, storage 330, a network 340, a memory 350. Object tracking unit 200 is stored in memory 340 of the tracking system 300. CPU 320 does the tracking process 200. Depending on the desired implementation, CPU 320 can be in the form of hardware processors, or a combination of hardware and software.

Image drawing unit 351 generates images showing the object tracking results. It contains methods such as drawing a rectangle over the area, or blurring or pixelating inside this area. The methods used depend on the application.

In example implementations as described herein, CPU 320 can be configured to, for a video feed with a provided object area of an object to be tracked, estimate a tracking area for the object to be tracked based on the provided object area and a scoring function; and utilizing the candidate tracking area to track the object in the video feed as illustrated in FIG. 1.

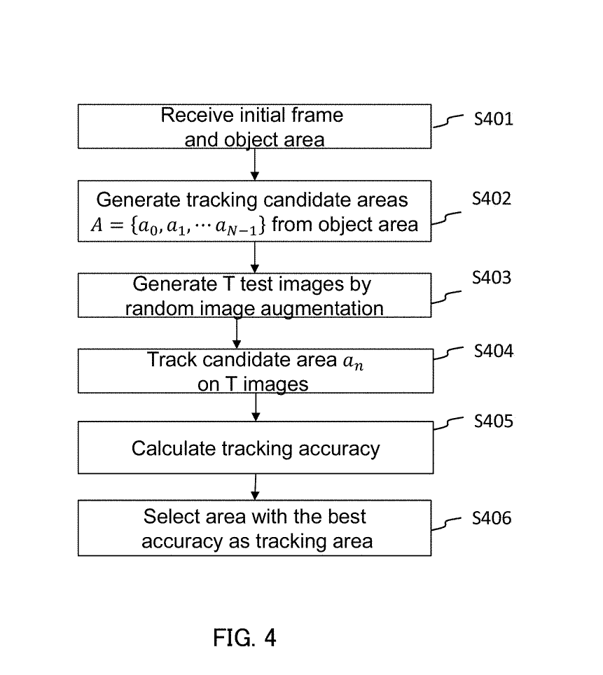

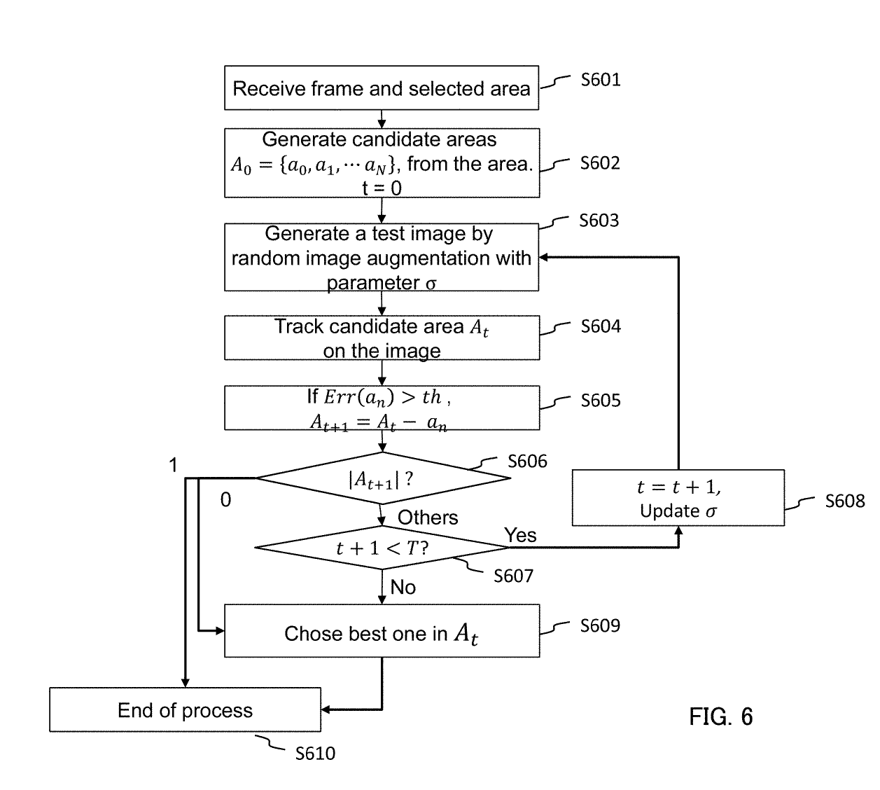

Depending on the desired implementation, CPU 320 can be configured to estimate the tracking area directed to the object to be tracked based on the provided object area and the scoring function through generating a plurality of candidate tracking areas of a video feed based on a provided object area of an object; and selecting a candidate tracking area from the plurality of candidate tracking areas based on a scoring function, as shown for example, in the examples of FIG. 4 and FIG. 6. The tracking area is estimated to be directed to the object to be tracked such that it functions as an appropriate tracking area for tracking the object (e.g., can track the object at a higher accuracy than if it were tracked by the object area).

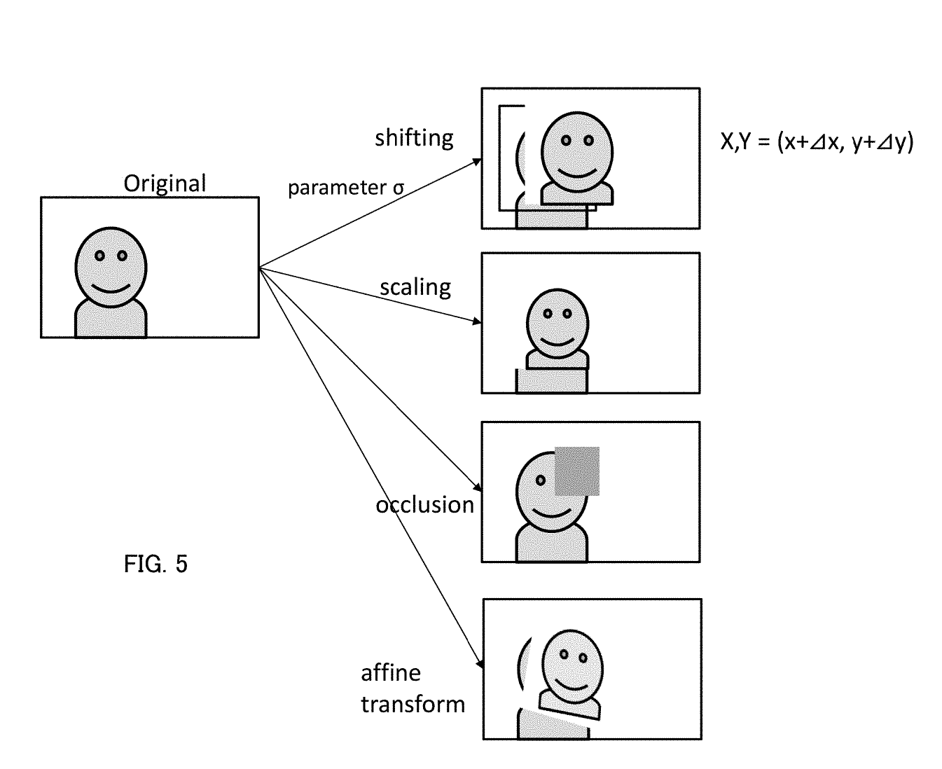

Depending on the desired implementation, CPU 320 can be configured to generate a plurality of test images from one or more image augmentation processes, the one or more image augmentation processes transforming an area around the provided object area of the object; and tracking the plurality of candidate tracking areas on the test images on the video feed as illustrated in FIG. 4 and FIG. 5. As described with respect to FIG. 4, the scoring function can be configured to score based on a tracking accuracy between each of the plurality of candidate tracking areas and the plurality of test images on the video feed.

Depending on the desired implementation, CPU 320 can be configured to a) generate a test image from an image augmentation process, the image augmentation process transforming an area around the provided object area of the object, b) track the plurality of candidate tracking areas on the test image on the video feed; c) use the scoring function to score the plurality of candidate tracking areas, the scoring function configured to score based on a tracking accuracy between each of the plurality of candidate tracking areas and the test image on the video feed; d) filter ones of the plurality of candidate tracking areas according to a threshold based on the score of the scoring function; and e) repeat steps a) to d) until a predetermined condition is met through the execution of the flow diagram of FIG. 6. wherein the selecting the candidate tracking area from the plurality of candidate tracking areas based on the scoring function comprises selecting the candidate tracking area from remaining ones of the plurality of candidate tracking areas having the score above the threshold.

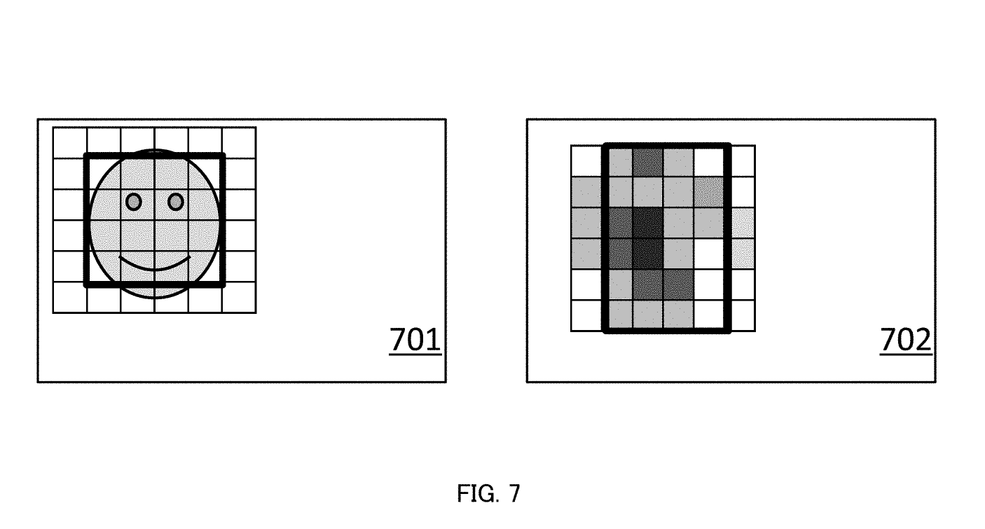

CPU 320 can be configured to estimate the tracking area for the object to be tracked based on the provided object area and the scoring function by conducting image feature extraction on a plurality of cells associated with the provided object area; scoring the plurality of cells based on the scoring function, the scoring function configured to score based on a distinctiveness of each cell of the plurality of cells; and generating the tracking area from one or more cells of the plurality of cells having a score meeting a threshold as illustrated and described in FIG. 7.

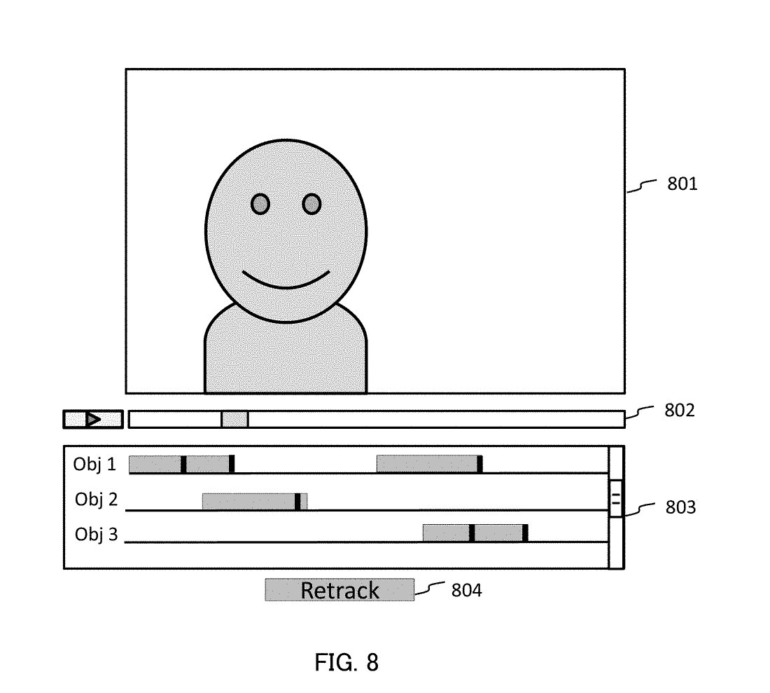

CPU 320 can also be configured to provide the video feed on a graphical user interface (GUI), the GUI configured to indicate the tracked object as illustrated in FIG. 8. Further, such GUIs can also be configured to display the object area based on a relationship between the tracking area and the object area for a given video frame of the video feed. The video feed can be real time video feed, wherein the displaying the object area is conducted on the real time video feed, or the video feed is archived video feed, wherein the displaying the object area is conducted on the archived video feed.

In example implementations for tracking area estimation, there are three methods to estimate the object tracking area with robustness. These example methods obtain the tracking area from the initial video frame, i.e. from the frame in which tracking starts, and from the object area in this frame. Subsequent frames need not be used in the estimation. The methods described herein involve rectangular object or tracking areas, but may be used for any other shape (e.g. circular areas) in accordance with the desired implementation. The methods described herein involve tracking forward in a video, but can also be used to track backwards in a video by using the previous frames instead of the next frames depending on the desired implementation.

The values described herein are effective ranges for the methods, however these methods are not limited to the values given and other value may be utilized in accordance according to the desired implementation (e.g., to trade accuracy versus computational speed).

First Example Implementation—Random Simulation Estimation

In a first example implementation, there is a random simulation estimation method which generates random tracking area candidates based on the position of the object area in the initial frame. In the first example implementation, the method also creates test images which transform the area around the object area in the initial video frame in using different forms of image augmentation. Each tracking area candidate between the initial frame and the test images is then tracked. Since the method for how generating each test image is known, the correct tracking for the test image can also be determined, and the accuracy given by each tracking area candidate can also be determined. The best tracking area candidate can thereby be selected as the tracking area.

FIG. 5 illustrates examples of image augmentation techniques, in accordance with an example implementation. Specifically, FIG. 5 illustrates example image augmentation techniques that can be used for evaluating candidate tracking areas randomly and for selecting the best tracking area based on the scoring function as defined in FIG. 4. The image augmentation techniques used to create test images include but are not limited to the techniques shown in FIG. 5, namely shifting, scaling, occlusion and affine transformations.

The area used for the augmentation techniques, herein referred to as the “augmentation area”, is obtained from the object area. In an example implementation, an area equal, narrower or wider than the object area is used for the augmentation. In an example implementation, a value between 80% and 120% of the width of the object area can be selected as the width of the augmentation area. The same can be applied to the height, in accordance with the desired implementation.

Each technique has a pre-defined limit parameter, and the degree of change is randomly selected within the limitation range:
For shifting, 30% of object area height or width
For scaling, 80% to 120% of the original size
For occlusion, add a square (e.g., black) or other shape within the object area with length of 30% to 50% of the object area height of width
For affine transform, change the x, y and z axes up to 30 degrees

Depending on the desired implementation, all of the augmentation techniques may be applied, or any of the techniques in singular or in combination can be selected in accordance with the desired implementation. One or more of the plurality of augmentation techniques in singular or in any combination can be used to generate each test image, in accordance with the desired implementation. Further, one image may be generated for each augmentation technique or each combination of augmentation techniques, or a plurality of images may be generated by changing the parameters for each technique depending on the desired implementation.

FIG. 4 illustrates an example processing flow of the first example implementation. Specifically, FIG. 4 illustrates a flow for conducting random simulation estimation. At S401, the first example implementation receives the image data of the initial frame and the object area position, such as the location of its top-left and bottom-right points on the initial frame. At S402, N candidates of tracking area are generated from the object area. Similarly to the above, a tracking area candidate can be obtained by shifting the object area up to 30% of the object area width or height, and/or scaling the object area by 80% to 120% of its original size. In an example implementation, a value of N between 5 and 6 can be effective. In S403, T test images are generated from an input image by different image augmentation processes as described above. The change of location used in the process is the correct answer for tracking. A value of T between 10 and 20 can be effective. At S404, object tracking of all candidates aₙ is processed between the initial image and all the T test images.

In S405, the tracking results are compared with the answers. The location error of candidate n on test image t is Err(rₙₜ). This error can be calculated as the distance between the centers of the tracking result area and the correct answer area. Then, the scoring function can be configured as the tracking accuracy Vₙ of candidate aₙ, which can be obtained by the following equation:

$${V}_{n} = \frac{1}{T} {\sum }_{t ∈ T} {( Err ( {r}_{nt} ) - \overline{Err} )}^{2}$$

In S406, the candidate aₙ with the smallest value of Vₙ is selected as the best tracking area.

Second Example Implementation—Sequential Simulation Estimation

FIG. 6 illustrates a processing flow of method to estimate object tracking area, in a second example implementation referred herein to as the “Sequential Simulation Estimation”. As shown in the following flow, example implementations can conduct a) generating a test image from an image augmentation process, the image augmentation process transforming an area around the provided object area of the object, b) tracking the plurality of candidate tracking areas on the test image on the video feed; c) using the scoring function to score the plurality of candidate tracking areas, the scoring function configured to score based on a tracking accuracy between each of the plurality of candidate tracking areas and the test image on the video feed; d) filtering ones of the plurality of candidate tracking areas according to a threshold based on the score of the scoring function; and e) repeating steps a) to d) until a predetermined condition is met.

In S601, the process receives current frame image and the selected area information as same as S401. In S602, N candidates of object area are randomly generated from the area. The candidates have some changes of location and scale based on the area as same as S402. t=0 is set.

In S603, one test image is generated by an image augmentation process. How much each augmentation technique should change the image is controlled by a separate parameter for this technique. This parameter can change within the pre-defined limit parameter for that technique, e.g. for shifting it will change from zero to 30% of object area height or width. All the parameters for the different augmentation techniques are correlated with a control parameter a, which can change between zero and one. When a is increased, the test image is changed more. For instance, on shifting, for σ=0 no shift is done, and for σ=1 the pre-defined limit of 30% of object area height or width is done.

In S604, object tracking by using candidates on the image is processed. In S605, the result location is compared with the correct one, and error distance value Err(aₙ) can be obtained and utilized as the scoring function. If the error is more than a pre-defined threshold, this candidate is rejected from all candidates Aₜ in the T-th iteration. The pre-defined threshold can be set at any value according to the desired implementation. In S606, if the number of candidates left is only one, this candidate is selected as the tracking area and the process proceeds to S610. If the number of candidates left is zero, the process proceeds to S609. For other cases, the process proceeds to S607.

In S607 if T test images have not been analyzed yet, then another iteration is conducted by proceeding to S608. Otherwise, the process proceeds to S609 to select the best candidate.

In S608, the process conducts some preparation for the next round of test and proceeds back to S603. The parameter a should be kept the same, or increased to generate an image with larger change in the next iteration. A simple way to update σ is to make σ=(t+1)/T, which will gradually increase σ. Alternatively, σ can be updated using the formula below, in which when a large number of candidates is dropped then a is increased slower, and vice-versa.

$$σ = σ + \frac{1}{T} ⋆ ( 1 - \frac{\vert {A}_{t} \vert - \vert {A}_{t + 1} \vert}{N} )$$

In S609, the best object candidates are selected from Aₜ, i.e. all candidates at iteration t. The candidate with the smallest average error on all iterations of the process is selected as the tracking area. In S610, the process is finalized.

As shown above, the preconditions can be set as iterations until only one candidate tracking area is left, until T images are processed, or through other methods depending on the desired implementation.

In the second example implementation, the calculation cost can be reduced compared to the random simulation estimation in the first example implementation. The latter takes N*T time, but the second example implementation typically needs (N*T)/2 or less time. The amount of computation can also be controlled by the parameter σ and how it is updated between iterations.

Third Example Implementation—Cell Area Based Estimation

FIG. 7 illustrates an image representing the third example implementation for the tracking area estimation, hereinafter referred to as cell area based estimation. This method is based on analyzing image features. The example implementation utilizes a patch based method wherein each block is evaluated. These image features can be computed by any desired implementation, such as through a Histogram of Oriented Gradients (HOG) or Convolutional Neural Networks (CNN).

At first as shown in 701, the object area is split into N*N cells, where each cell has a plurality of pixels. Then, the image feature is extracted from each (N+a)*(N+a) cells, including cells outside the object area. There are no limitations to the values of “N” and “a”, but value ranges between 5 and 10 for “N”, and between 1 to 3 for “a” are effective. After that, an image feature fᵢⱼ is extracted from image cell in position (i, j). Comparing the image features of a cell and the ones around it, the distinctiveness of this cell can be obtained. The distinctiveness D_{(i,j)} of the cell at position (i, j) is evaluated by the following equations (with calculation at the borders only including the cells within the (N+a)*(N+a) space):

$${R}_{( i , j ) , ( i + 1 , j )} = sqrt ( {f}_{i , j}^{2} - {f}_{i + 1 , j}^{2} )$$

$${D}_{( i , j )} = {\sum }_{r ∈ [ i - 1 \leq {i}^{′} \leq i + 1 , j - 1 < {j}^{′} < j + 1 ]} {R}_{r} / \vert r \vert$$

In image 702, the distinctiveness of each cell is represented by the color gradient, with white meaning high distinctiveness and black meaning low distinctiveness. The tracking area can be obtained as the group of cells with the lowest average value of distinctiveness. To guarantee a minimum size for the tracking area we can specify a minimum length for its side of e.g. N−a cells, or a minimum of e.g. N*N cells in total.

In the third example implementation, this implementation delivers high processing speed since it does not need an iterative process to obtain the tracking area. However, how precisely the position of the tracking area can be determined is limited by the cell size, i.e. the third example implementation may have low granularity in determining the position of the tracking area.

Example Applications

1) Automatic Area Selection

An example of an application of tracking in which the object area is automatically selected is industrial applications. As previously stated, it can be used to e.g. track workers or parts in a factory floor, where they are automatically detected in the video. Tracking may be combined with detection, and the resulting tracking data may be used as input to different applications.

One such example is to find problems in an assembly line from the position of the worker. For instance, in a manufacturing process in which a worker must move sequentially between three work cells 1 to 3, then back to work cell 1, a camera viewing all work cells can be placed, and the position of the work cells in the video image can be determined. Then, detection and tracking can be utilized to see if the position of the worker corresponds to the expected process. If a worker stays for too long in a work cell, or skips a work cell, an alert can be generated to indicate a problem.

Another possible application is tracking parts passing in a conveyor belt to be put in different pallets for sorting or warehousing. The conveyor belt will have a plurality of actuators in different positions to move parts out of the conveyor belt into the pallets. Tracking is used here to see when a part is at the correct actuator, so it can be activated.

2) Manual Area Selection

FIG. 8 is a sample of a Graphical User Interface (GUI) tool for object area selection, in accordance with an example implementation. A GUI, graphical user interface, 801 shows video image and object tracking result on the image and the position in the video can be controlled by a slider bar 802. Element 803 shows tracked objects in the playing video, and the black rectangle is a flag showing a possible tracking error. This possible error can be obtained by applying a threshold to the confidence value calculated by the tracking process. If the tracking confidence is lower than a defined threshold, the flag is shown on the bar. And if the user clicks the flag, the GUI window skips to the frame with the flag. The user can easily see the frame and check if errors exist or not.

In this example implementation, there is also the re-track button 804. When a user clicks the button, the tracking area estimation 240 is applied to all of frames that have a black flag. If a better tracking area which is different from the current object area is found, the tracking process is restarted from the frame with the black flag. By using this re-track function, the user can get more correct tracking results without manual checking.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “managing,” “processing,” “computing,” “calculating,” “determining,” “adjusting,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for a video feed with a provided object area of an object to be tracked, estimating a tracking area directed to the object to be tracked based on the provided object area and a scoring function; and
utilizing the tracking area to track the object in the video feed.

2. The method of claim 1, wherein the estimating the tracking area directed to the object to be tracked based on the provided object area and the scoring function comprises:
generating a plurality of candidate tracking areas of a video feed based on a provided object area of an object; and
selecting a candidate tracking area from the plurality of candidate tracking areas based on a scoring function.

3. The method of claim 2, further comprising:
generating a plurality of test images from one or more image augmentation processes, the one or more image augmentation processes transforming an area around the provided object area of the object;
tracking the plurality of candidate tracking areas on the test images on the video feed; and
wherein the scoring function is configured to score based on a tracking accuracy between each of the plurality of candidate tracking areas and the plurality of test images on the video feed.

4. The method of claim 2, further comprising:
a) generating a test image from an image augmentation process, the image augmentation process transforming an area around the provided object area of the object
b) tracking the plurality of candidate tracking areas on the test image on the video feed;
c) using the scoring function to score the plurality of candidate tracking areas, the scoring function configured to score based on a tracking accuracy between each of the plurality of candidate tracking areas and the test image on the video feed;
d) filtering ones of the plurality of candidate tracking areas according to a threshold based on the score of the scoring function; and
e) repeating steps a) to d) until a predetermined condition is met;
wherein the selecting the candidate tracking area from the plurality of candidate tracking areas based on the scoring function comprises selecting the candidate tracking area from remaining ones of the plurality of candidate tracking areas having the score above the threshold.

5. The method of claim 1, wherein the estimating the tracking area directed to the object to be tracked based on the provided object area and the scoring function comprises:
conducting image feature extraction on a plurality of cells associated with the provided object area;
scoring the plurality of cells based on the scoring function, the scoring function configured to score based on a distinctiveness of each cell of the plurality of cells; and
generating the tracking area from one or more cells of the plurality of cells having a score meeting a threshold.

6. The method of claim 1, further comprising providing the video feed on a graphical user interface (GUI), the GUI configured to indicate the tracked object.

7. The method of claim 1, further comprising displaying the object area based on a relationship between the tracking area and the object area for a given video frame of the video feed.

8. A non-transitory computer readable medium, storing instructions for executing a process, the instructions comprising:
for a video feed with a provided object area of an object to be tracked, estimating a tracking area directed to the object to be tracked based on the provided object area and a scoring function; and
utilizing the tracking area to track the object in the video feed.

9. The non-transitory computer readable medium of claim 8, wherein the estimating the tracking area directed to the object to be tracked based on the provided object area and the scoring function comprises:
generating a plurality of candidate tracking areas of a video feed based on a provided object area of an object; and
selecting a candidate tracking area from the plurality of candidate tracking areas based on a scoring function.

10. The non-transitory computer readable medium of claim 9, the instructions further comprising:
generating a plurality of test images from one or more image augmentation processes, the one or more image augmentation processes transforming an area around the provided object area of the object;
tracking the plurality of candidate tracking areas on the test images on the video feed; and
wherein the scoring function is configured to score based on a tracking accuracy between each of the plurality of candidate tracking areas and the plurality of test images on the video feed.

11. The non-transitory computer readable medium of claim 9, the instructions further comprising:
a) generating a test image from an image augmentation process, the image augmentation process transforming an area around the provided object area of the object
b) tracking the plurality of candidate tracking areas on the test image on the video feed;
c) using the scoring function to score the plurality of candidate tracking areas, the scoring function configured to score based on a tracking accuracy between each of the plurality of candidate tracking areas and the test image on the video feed;
d) filtering ones of the plurality of candidate tracking areas according to a threshold based on the score of the scoring function; and
e) repeating steps a) to d) until a predetermined condition is met;
wherein the selecting the candidate tracking area from the plurality of candidate tracking areas based on the scoring function comprises selecting the candidate tracking area from remaining ones of the plurality of candidate tracking areas having the score above the threshold.

12. The non-transitory computer readable medium of claim 8, wherein the estimating the tracking area directed to the object to be tracked based on the provided object area and the scoring function comprises:
conducting image feature extraction on a plurality of cells associated with the provided object area;
scoring the plurality of cells based on the scoring function, the scoring function configured to score based on a distinctiveness of each cell of the plurality of cells; and
generating the tracking area from one or more cells of the plurality of cells having a score meeting a threshold.

13. The non-transitory computer readable medium of claim 8, the instructions further comprising providing the video feed on a graphical user interface (GUI), the GUI configured to indicate the tracked object.

14. The non-transitory computer readable medium of claim 8, the instructions further comprising displaying the object area based on a relationship between the tracking area and the object area for a given video frame of the video feed.
